(19) United States
(12) Patent Application Publication
(10) Pub. No.: US 2008/0254082 A1
(43) Pub. Date: Oct. 16, 2008

(54) Methods for Crop Protection

(75) Inventors: Ofer Toledano, Kfar-Saba (IL); Iris Binyamin, Nes Ziona (IL); Haim Bar-Simantov, Modiin (IL); Alon Seri-Levy, Rehovot (IL)

Correspondence Address: BROWDY AND NEIMARK, P.L.L.C.;624 NINTH STREET, NW, SUITE 300, WASHINGTON, DC, 20001-5303, US

(73) Assignee: SOL-GEL TECHNOLOGIES LTD., Beit Shemesh (IL)

(21) Appl. No.: 12/088,297

(22) PCT Filed: Sep. 27, 2006
(86) PCT No.: PCT/IL2006/001136

§ 371 Date: May 27, 2008

Related U.S. Application Data
(60) Provisional application No. 60/720,477, filed on Sep. 27, 2005.

(51) Int. Cl. A01N 25/28; A01N 57/16; A01N 53/06; A01N 43/653; A01P 15/00

(52) U.S. Cl. 424/408; 514/89; 514/531; 514/383

(57) ABSTRACT

The invention relates to a method for crop protection comprising administering to one or both of the crop and its environment a composition comprising a carrier; and microcapsules having a core material comprising a pesticide encapsulated by a silica shell, wherein the silica shell constitutes up to 10% w/w out of the total weight of the microcapsules, and wherein said administration gives rise to pesticide activity with immediate onset and prolonged effect. The invention further relates to a method for acute treatment of a pest-infested crop.

### FIELD OF THE INVENTION

The present invention generally relates to methods for crop protection and more particularly to methods for crop protection using a microcapsular composition.

### BACKGROUND OF THE INVENTION

Various compositions and methods have been described in the art to microencapsulate a pesticide. Despite remarkable progress in the development of microencapsulated pesticides, the prior art mainly relates to an organic polymer capsule wall such as described in U.S. Pat. Nos. 5,277,979, 5,304,707, 5,972,363, 5,273,749, 5,576,008, 5,866,153, 6,506,397, 6,485,736 B1, and in WO9002655 and WO0005952. These polymers are usually not biodegradable and cause irreversible environmental damage. Further there are problems associated with encapsulating bioactive compounds such as pesticides: the compounds may be incompatible with typical encapsulation processes, and it may be difficult to control the release of the compound from the encapsulating material to obtain the desired effect.

Another media for controlled delivery of an active ingredient, is doping within sol-gel matrices. In this method, monoliths, particles or other forms (such as thin layers, or fibers) are made, and the active ingredient is immobilized in the pores of the sol-gel matrix. The sol-gel matrix is doped with small amounts of the active ingredient. This method is utilized, for example, in U.S. Pat. Nos. 6,090,399, 5,591,453, 4,169,069, and 4,988,744, and in DE 19811900, WO 9745367, WO 00/47236, WO 98/31333, U.S. Pat. No. 6,495,352, and U.S. Pat. No. 5,292,801.

Sol-gel doped matrices, however, cannot support high loading (above 20 weight percents) of the active ingredient. In order to obtain high loading, it is essential to form a core-shell structure, where most of the weight of the capsule is the weight of the encapsulated active ingredient and where the thin shell protects the core effectively.

U.S. Pat. Nos. 6,303,149, 6,238,650, 6,468,509, 6,436,375, US2005037087, US2002064541, and International publication Nos. WO 00/09652, WO00/72806, WO 01/80823, WO 03/03497, WO 03/039510, WO00/71084, WO05/009604, and WO04/81222, disclose sol-gel microcapsules and methods for their preparation. EP 0 934 773 and U.S. Pat. No. 6,337,089 teach microcapsules containing core material and a capsule wall made of organopolysiloxane, and their production. EP 0 941 761 and U.S. Pat. No. 6,251,313 also teach the preparation of microcapsules having shell walls of organopolysiloxane.

U.S. Pat. No. 4,931,362 describes a method of forming microcapsules or micromatrix bodies having an interior water-immiscible liquid phase containing an active, water-immiscible ingredient. As a capsule-forming or matrix-forming monomer, an organosilicon compound is used.

For pesticidal delivery it will be desired to develop a composition capable of retaining knock down efficacy and yet having reduced toxicity.

One on the first encapsulation technologies claiming reduced toxicity and having knockdown efficacy is the Zeon technology. The Zeon technol. for microencapsulation of Lambda-cyhalothrin insecticide was developed at Zeneca's Western Research Center. By use of isocyanate interfacial polymerization chemistry and Zeneca's novel protective colloids and emulsifiers system, a process was developed for high active ingredient loading microencapsulation. As a result of this technology, toxicity in nearly all categories was reduced compared with the EC (Emulsifiable Concentrate) formulation (Microencapsulation of lambda-cyhalothrin for crop protection—the zeon technology. Sheu, E. Y. Western Research Center, Zeneca Ag Products, Richmond, Calif., USA. BCPC Symp. Proc. (2000), 74 57-64.).

A disadvantage of Zeon technology microencapsulation system is that traces of the diisocymate in the core may result in instability of the core material or release of carbon dioxide due to reaction with water. Therefore the technology is very “core-dependent” which limits it to specific cases of pesticides. Further organic polymers like polyurea may cause environmental contamination (e.g. effect the environmental balance in the soil).

It is of great environmental interest to develop a delivery system capable of encapsulating a pesticide in a high loading within an environmental safe formulation and which is capable of delivering the active ingredient to its site of action in as efficient a manner as possible.

There is a widely recognized need and it will be highly advantageous to have a method for crop protection using a delivery system which is capable of providing pesticide activity with immediate onset and prolonged effect and yet which is characterized by low toxicity and side effects (i.e. having reduced mammalian, or environmental toxicity). Further there is a need for a method for crop protection using a composition capable of retaining the knock down efficacy.

Further there is a need for a pesticidal delivery system capable of acute treatment of a pest-infested crop, with reduced toxicity and side effects.

### SUMMARY OF THE INVENTION

According to one aspect of the present invention there is provided a method for crop protection comprising administering to one or both of the crop and its environment a composition comprising a carrier; and microcapsules having a core material comprising a pesticide encapsulated by a silica shell, wherein the silica shell constitutes up to 10% w/w out of the total weight of the microcapsules, and wherein said administration gives rise to pesticide activity with immediate onset and prolonged effect.

According to another aspect of the present invention there is provided a method for acute treatment of a pest-infested crop comprising administering to one or both of the crop and its environment a composition comprising a carrier; and microcapsules having a core material comprising a pesticide encapsulated by a silica shell, wherein the silica shell constitutes up to 10% w/w out of the total weight of the microcapsules.

### DETAILED DESCRIPTION OF THE INVENTION

The present invention is based on the findings that it is possible to obtain a pesticidal activity with immediate release and prolonged effect capable of retaining the knock down effect thus providing superior beneficial crop protection using sol-gel microcapsules having a core material comprising a pesticide encapsulated by a microcapsular silica shell, where the silica shell constitutes up to 10% w/w out of the total weight of the microcapsules.

It was also found that such microcapsules are useful in acute treatment of a pest-infested crop, where the silica shell constitutes up to 10% w/w preferably up to 1% w/w out of the total weight of the microcapsules.

Surprisingly, sol-gel microcapsules having a silica shell can be designed to achieve triggered release of their contents, for example in an immediate manner following administration, or in an immediate manner followed by a sustained manner following administration to the crop and/or its environment. The technology also provides release of the microcapsule contents following a specific triggering incident, which is applied after application keeping the core/shell structure unharmed during shelf life. Such incidents are dehydration, mechanical brakeage, changes in pH, etc. Moreover, the microcapsules can protect the pesticide active ingredient prior to delivery, increasing stability and extending product shelf life. The sol-gel microencapsulation allows stabilization of the pesticide for a prolonged period of time, by forming a protective layer around said pesticide.

Surprisingly it was found that small quantities of silica are capable of causing reduced side effects and toxicity and retaining a knock down effect over a prolonged period compared with an unencapsulated pesticide.

Without being bound to theory, it is assumed that following application (administration), the microcapsules rupture, releasing their contents, thereby functioning as a delivery system. Prior to release, however, the capsules remain intact and of relatively uniform size range, for prolonged periods of time.

While conventionally microcapsules have been prepared by coating the core material with organic polymers, in sol-gel microencapsulation technology, the core material is typically coated with inorganic polymers. This imparts unique properties to the microcapsular wall, such as rigidity, and sensitivity to friction, which may facilitate release of microcapsular contents.

The use of inorganic polymer (silica) for the microcapsular wall further grants the ability to control the pore size of the microcapsular shell, and due to its inertness eliminates sensitivity of the shell to both the carrier such as presence of organic solvents in the formulation, or to other microenvironments surrounding the shell.

Coating pesticides with silica as described in the present invention is highly advantageous. The benefit for silica coating of pesticides is to provide an effective treatments by providing an immediate onset of activity and prolonged release and yet to have the toxicity, in nearly all categories, reduced compared to the uncoated product. The added value of silica coating of pesticides is the perfect tolerability silica has with the environment since most soils contain large amounts of silica. Further, the sol-gel technology is completely independent of the core material. The tetra alkoxy silane used in the preparation of the silica microcapsules will be consumed (used) completely due to it's good permeability through the capsule wall. The silica formed is compatible with most organic compounds and will not decompose the core material. Silica is present in soil as sand so an addition of it through pesticidal formulations will not effect the environmental balance in the soil.

In the present invention, the term “pesticide” refers to a molecule or combination of molecules that repels, retards, or kills pests, such as, but not limited to, deleterious or annoying insects, weeds, worms, fungi, bacteria, and the like, and can be used especially for crop protection, but also for other purposes such as edifice protection; turf protection; pesticide as used herein includes, but is not limited to, herbicides, insecticides, acaricides, fungicides, herbicides, nematicides, ectoparasiticides, and growth regulators, either used to encourage growth of a desired plant species or retard growth of an undesired pest.

In the present invention, the term “silica shell constitutes up to 10% w/w out of the total weight of the microcapsules” refers to a weight percentage of the of the shell up to 10% (w/w) based on the total weight of the microcapsules. Similarly the term “silica shell constitutes up to 1% w/w out of the total weight of the microcapsules” refers to a weight percentage of the of the shell up to 1% (w/w) based on the total weight of the microcapsules. As the microcapsules constitute a population with different concentrations of silica shell material, this term refers to an average value of all measured microcapsules.

Thus, the present invention relates to a method for crop protection comprising administering to one or both of the crop and its environment a composition comprising a carrier; and microcapsules having a core material comprising a pesticide encapsulated by a silica shell, wherein the silica shell constitutes up to 10% w/w out of the total weight of the microcapsules, and wherein said administration gives rise to pesticide activity with immediate onset and prolonged effect.

The method according to the invention can be employed advantageously for controlling pests in crops such as rice, cereals such as maize or sorghum; in fruit, for example stone fruit, pome fruit and soft fruit such as apples, pears, plums, peaches, almonds, cherries or berries, for example strawberries, raspberries and blackberries; in legumes such as beans, lentils, peas or soya beans; in oil crops such as oilseed rape, mustard, poppies, olives, sunflowers, coconuts, castor-oil plants, cacao or peanuts; in the marrow family such as pumpkins, cucumbers or melons; in fibre plants such as cotton, flax, hemp or jute; in citrus fruit such as oranges, lemons, grapefruit or tangerines; in vegetables such as spinach, lettuce, asparagus, cabbage species, carrots, onions, tomatoes, potatoes, beet or capsicum; in the laurel family such as avocado, Cinnamonium or camphor; or in tobacco, nuts, coffee, egg plants, sugar cane, tea, pepper, grapevines, hops, the banana family, latex plants or ornamentals, mainly in maize, rice, cereals, soya beans, tomatoes, cotton, potatoes, sugar beet, rice and mustard.

According to the invention, it is possible to treat all crop plants and parts of plants. By plants are to be understood here all plants and plant populations (including naturally occurring crop plants). Crop plants can be plants which can be obtained by conventional breeding and optimization methods or by biotechnological and genetic engineering methods or combinations of these methods. Parts of plants are to be understood as meaning all above-ground and below-ground parts and organs of plants, such as shoot, leaf, flower and root, examples which may be mentioned being leaves, needles, stems, trunks, flowers, fruit bodies, fruits and seeds and also roots, tubers and rhizomes. Parts of plants also include harvested plants and vegetative and generative propagation material, for example seedlings, tubers, rhizomes, cuttings and seeds.

The administration of the composition of the present invention for treatment of the plants and parts of plants according to the invention with the pesticide active compounds is carried out directly or by action on their environment (such as the soil, habitat or storage area) according to customary treatment methods, for example by dipping, spraying, brushing-on, injecting (for example injection into the soil). Such compositions are typically designated for pre-emergent or post-emergent application.

According to a preferred embodiment of the present invention, the concentration of the silica shell based on the total weight of the microcapsules is in the range 1-10% w/w.

More preferably the concentration of the silica shell based on the total weight of the microcapsules is in the range 1-5% w/w. Most preferably the concentration of the silica shell based on the total weight of the microcapsules is in the range 1-4% w/w.

As used herein the term “core material” refers to the inside part of the microcapsules comprising the pesticide that is surrounded by the shell of the microcapsules. The core material refers to both the pesticide active ingredient and the optional excipients such as the liquid carrier. The liquid carrier is used to dissolve or disperse the pesticide.

Preferably the concentration of the pesticide based on the total weight of the core material is in the range of 2-100% w/w, more preferably 10-100% w/w and most preferably in the range 20-100% w/w.

Preferably the core material is a water-insoluble core.

Additionally according to a preferred embodiment of the present invention, the core material is a liquid core.

More preferably the liquid core is a water insoluble liquid core.

According to a preferred embodiment of the present invention, the pesticide is dissolved or dispersed in said liquid core.

Further according to a preferred embodiment of the present invention, the core material is in the form of semi-solid core such as a paste or a wax.

The pesticide may be dissolved or dispersed in said semi-solid core.

Thus, the core material may also include excipients (e.g. water insoluble solvents) which are needed for the preparation of the microcapsules or to dissolve the active ingredient. Preferably the concentration of the excipients based on the total weight of the core is up to 98% w/w, more preferably up to 90% w/w and most preferably up to 80% w/w.

At times, the core material may also be the pesticide (i.e. does not include excipients such as a liquid carrier).

Where the pesticide is an oil or a solid which can be dissolved in the silicon alkoxide monomer and additional excipients such as solvents or co-solvents are not needed in order to prepare the oily phase of the emulsion used in the process, in this case the core material of the formed microcapsules is the pesticide.

When the pesticide is a solid it will be advantages to dissolve the pesticide in a water-insoluble solvent at a desired concentration of the pesticide. In this case the core material comprises an excipient (i.e. a water insoluble solvent) and the pesticide.

Preferably the compositions for pest control described above comprise a carrier, wherein the microcapsules are dispersed in said carrier.

Further according to a preferred embodiment of the present invention, the carrier is an aqueous-based carrier. Most preferably the aqueous-based carrier is whole water and may additionally include additives such as dispersing/wetting agents, viscosity imparting agents, etc.

The microcapsules may be employed in the form of mixtures with a solid, semi solid or liquid dispersible carrier vehicles and/or other known compatible active agents such as other pesticides, or fertilizers, growth-regulating agents, etc., if desired, or in the form of particular dosage preparations for specific application made therefrom, such as solutions, emulsions, suspensions, powders, pastes, foams, tablets, polymeric sheets, aerosols, etc. and which are thus ready for use. Most preferably the preparation is in the form of a suspension of said microcapsules in an aqueous medium (carrier).

The pesticide is preferably water insoluble. The term water insoluble with respect to the pesticide refers to solubility in water of less than 1% w/w, typically less than 0.5% and at times less than 0.1% w/w at room temperature (20° C.).

According to a preferred embodiment of the present invention, the pesticide is selected from a herbicide, an insecticide, a fungicide, and mixtures thereof.

The herbicide may be for example Quinoline, Dimethenamid, Aclonifen, Anilofos, Asulam, Bromoxynil, Diflufenican, Ethofumesate, Ethoxysulfuron, Fenoxaprop, Fentrazamide, Idosulfuron, Metribuzin, Oxadiazon, Phenmedipham, Mesotrione, S-metolachlor, Trifloxysulfuron sodium, Fluazifop-p-butyl, Clodinafop-propargyl, Pinoxaden, Pyriftalid, Propaquizafop, or mixtures of any of the above.

The insecticide may be for example Fenobucarb, Carbofuran, Carbaryl, Isoprocarb, Metolcarb, Propoxur, Methomyl, Aldicarb, Dimethomorph, Terbufos, Thiodicarb, Profenofos, Fenoxycarb, Pirimicarb, Cypermethrin, Deltamethrin, Permethrin, Lambda-cyhalothrin, Bifenthrin, Cyfluthrin and Beta-cyfluthrin, Tefluthrin, Chlorpyrifos, Diazinon, Dimethoate, Malathion, Phenthoate, Azinphos-methyl, DDVP, Fenamiphos, Methamidofos, Monocrotophos, Methidathion, Fipronil, Endosulfan, Dicofol, avermectin, abamectin, and ivermectin, Novaluron, Buprofezin, Flufenoxuron, Triflunuron, Lufenuron, Diafenthiuron, Cyromazine, Imidaclopride, Thiamethoxam, Niclosamide, Thiacloprid, Clofentezine, Pymetrozine, Fosthiazate, Emamectin benzoate, or mixtures of any of the above.

The fungicide may be for example Captan, Folpet, Tebuconazole, Epoxiconazole, Propiconazole, Thiabendazole, Triticonazole, Cyproconazole, Prothioconazole, Triadiminol, Difenoconazole, Kresoxim-Methyl, Azoxystrobin, Pyraclostrobin, Metominostrobin, Trifloxystrobin, Imazalil, Chlorothalonil, Fenamidon, Prochloraz, Pyrimethanil, Qyprodinil, Mefenoxam, or mixtures of any of the above.

The amounts of pesticides that can be used for a specific application, can be found in guidelines issued by the ministry of agriculture in each country.

Moreover according to a preferred embodiment of the present invention, the silica shell is produced by a sol-gel process comprising in-situ polymerization of silicon alkoxide monomers having the formula Si(OR)₄ where R is C₁-C₆ alkyl.

As used herein the term “in situ polymerization” refers to the sol-gel polymerization process of a sol-gel precursor (silicon alkoxide monomers) forming silica shell at the oil-water interface of the emulsion as a result of the hydrolysis and condensation reactions of the sol-gel precursor.

Additionally according to a preferred embodiment of the present invention, the silicon alkoxide monomer is selected from tetramethoxy silane, tetraethoxy silane, and mixtures thereof.

The precursor (silicon alkoxide monomer) may be a single monomeric unit or alternatively the precursor may be comprised of a number of monomeric units.

For example, the precursor may be an oligomer of the precursor for example, a prehydrolyzed tetraethoxy silane (TEOS) which is based on the hydrolysis of TEOS, which may be used in order to obtain short chain polymers that can also be used for encapsulation.

Most preferably the silicon alkoxide monomer or oligomer forms a pure silica shell (i.e. not an organically modified silica).

The microcapsules are preferably prepared by a sol-gel process according to the methods disclosed in U.S. Pat. No. 6,303,149 and WO2005/009604, incorporated herein by reference in their entirety.

The process of the present invention is based on the preparation of an oil-in-water emulsion by emulsifying a hydrophobic solution (oily phase) that comprises the precursors and the core material comprising the at least one pesticide, in aqueous solution, with or without the need for mixing said emulsion with another aqueous solution to accelerate the condensation-polymerization reaction.

According to a preferred embodiment of the present invention, the microcapsules are prepared by a process comprising:
preparing an oil-in-water emulsion by emulsification of a water insoluble liquid phase comprising a water insoluble silicon alkoxide monomers having the formula Si(OR)₄ where R is C₁-C₆ alkyl and the core material, in an aqueous phase comprising an aqueous solution having a pH in the range 2-13, under appropriate shear forces and temperature conditions.

Moreover according to a preferred embodiment of the present invention, the pH is in the range 2-7.

The process may further comprise mixing and stirring the emulsion obtained with an aqueous solution having a pH in the range 2-13 to obtain loaded sol-gel microcapsules in a suspension.

As used herein the term “C₁-C₆ alkyl” refers to a saturated aliphatic hydrocarbon of 1 to 6 carbon atoms. The numerical range “1 to 6” stated herein means that the alkyl group, may contain 1 carbon atom, 2 carbon atoms, 3 carbon atoms, etc., up to and including 6 carbon atoms.

Further according to a preferred embodiment of the present invention, the weight ratio of the silicon alkoxide monomers to said core material is in the range 3:97 to 30:70.

Still further according to a preferred embodiment of the present invention, the weight ratio of the silicon alkoxide monomers to said core material is in the range 3:97 to 15:85.

Moreover according to a preferred embodiment of the present invention, the weight ratio of the silicon alkoxide monomers to said core material is in the range 3:97 to 11:89.

The particle size of the microcapsules may be in the range of 0.01-1000 μm in diameter, preferably 0.1-100 μm in diameter and more preferably 1-10 μm in diameter.

According to a preferred embodiment of the present invention, the composition providing a knock down effect and reduced toxicity.

By “knock down effect” is meant an effect causing preferably 80-100% mortality of the pest (such as insect, fungi, weed and the like) within 24 hours after application (administration).

The term “pesticidal activity with immediate onset” refers to a knock-down effect causing preferably 80-100% mortality of the pest (such as insect, fungi, weed and the like) within 24 hours after application (administration).

Preferably the prolonged pesticidal effect manifested by a prolonged knock down effect (i.e. causing 80-100% mortality of the pest) is for a period of up to 30 days (following administration). The prolonged knock down effect may be up to 14-20 days.

According to a preferred embodiment of the present invention the prolonged pesticidal effect is up to 60 days (following administration). The prolonged pesticidal effect may be for 14 to 60 days or more preferably for 30 to 60 days.

As used herein the term “prolonged pesticidal effect” (or “pesticidal activity with prolonged effect”) refers to an effect causing preferably at least 30% mortality of the pest (such as insect, fungi, weed and the like), preferably for the time duration indicated above. Most preferably the prolonged pesticidal effect is manifested by a prolonged knock down effect (i.e. causing 80-100% mortality of the pest) as described above.

The above treatments refer to one administration (application) of the composition. In order to prolong the effect the composition may be administered more frequently for example one per month or one per 6 weeks depending on the desired effect.

The toxicity may refer to mammalian toxicity such as oral toxicity, dermal toxicity, skin irritation, eye irritation, paraesthesia or environmental toxicity for example marine species toxicity, toxicity to alga ect.

By “paraesthesia” is meant sensation of tingling, pricking, or numbness of a person's skin with no apparent long-term physical effect, more generally known as the feeling of pins and needles.

Additionally according to a preferred embodiment of the present invention, the composition having reduced toxicity and at least essentially the same pesticidal effect as compared to a reference composition; the difference between said composition and the reference composition being in that in the latter the pesticide is not coated.

Preferably the microcapsules are non-leaching when dispersed in a carrier.

Preferably the term “non-leaching” refers to leaching of a pesticide from the core of the microcapsules in an amount less than 2% w/w, more preferably less than 1% w/w more preferably less than 0.5% w/w more preferably less than 0.2% w/w and most preferably 0.1-0.2% w/w based on the total weight of the pesticide in the core of the microcapsules. The above values refer to leaching at room temperature (20° C.) into an aqueous solutions after shaking until steady state of the concentration is achieved.

Without being bound to theory it is assumed that upon administration (application) of the pesticidal composition to the target site (i.e. crop and/or its environment), the silica shell wall ruptures as a result of the evaporation of water (present in the carrier). This causes an immediate collapse and rupture of the shell and onset of release of the pesticide, followed by a release in a controlled manner as a result of the volatility of the pesticide.

Release of the pesticide from the microcapsules can also be obtained and controlled by aging time, thermal treatment or any mechanical mean that can change the characteristic porosity or strength of the shell, or by chemical means such as organic polymers and/or surfactants that may be added while the microcapsules are being formed, to control the surface nature of the shell and the rate of diffusion through the pores.

The present invention additionally relates to a method for acute treatment of a pest-infested crop comprising administering to one or both of the crop and its environment a composition comprising a carrier; and microcapsules having a core material comprising a pesticide encapsulated by a silica shell, wherein the silica shell constitutes up to 10% w/w out of the total weight of the microcapsules.

As used herein acute treatment refers to pest activity preferably showing mortality of the pesticide ranging between 80-100% within 24 hours and more preferably between 90-100% within 24 hours.

According to a more preferred embodiment of the present invention, the concentration of the silica shell based on the total weight of the microcapsules is up to 3% w/w. The concentration may be in the range 0.1-3% w/w.

According to even more preferred embodiment of the present invention, the concentration of the silica shell based on the total weight of the microcapsules is up to 1% w/w. The concentration may be in the range 0.1-1% w/w.

Additionally according to even more preferred embodiment of the present invention, the concentration of the silica shell based on the total weight of the microcapsules is in the range 0.1 to 0.95% w/w.

Preferably the core material is a water-insoluble core.

Further according to a preferred embodiment of the present invention, the core material is a liquid core.

Still further according to a preferred embodiment of the present invention, the liquid core is a water insoluble liquid core.

Moreover according to a preferred embodiment of the present invention, the pesticide is dissolved or dispersed in said liquid core.

Further according to a preferred embodiment of the present invention, the core material is in the form of semi-solid core such as a paste or a wax.

The pesticide may be dissolved or dispersed in said semi-solid core.

Additionally according to a preferred embodiment of the present invention, the carrier is an aqueous-based carrier. Most preferably the aqueous-based carrier is as described above.

The microcapsules may be easily dispersed or suspended in the carrier or diluent. Simple mixing with any suitable mixer or stirrer is sufficient to achieve an effective dispersion. If necessary high shear forces may be applied to facilitate fast and efficient mixing of the microcapsules in the carrier.

Further according to a preferred embodiment of the present invention, the pesticide is selected from a herbicide, an insecticide, a fungicide, and mixtures thereof.

The pesticide is preferably water insoluble as described above.

The herbicide may be for example Quinoline, Dimethenamid, Aclonifen, Anilofos, Asulam, Bromoxynil, Diflufenican, Ethofumesate, Ethoxysulfuron, Fenoxaprop, Fentrazamide, Idosulfuron, Metribuzin, Oxadiazon, Phenmedipham, Mesotrione, S-metolachlor, Trifloxysulfuron sodium, Fluazifop-p-butyl, Clodinafop-propargyl, Pinoxaden, Pyriftalid, Propaquizafop, or mixtures of any of the above.

The insecticide may be for example Fenobucarb, Carbofuran, Carbaryl, Isoprocarb, Metolcarb, Propoxur, Methomyl, Aldicarb, Dimethomorph, Terbufos, Thiodicarb, Profenofos, Fenoxycarb, Pirimicarb, Cypermethrin, Deltamethrin, Permethrin, Lambda-cyhalothrin, Bifenthrin, Cyfluthrin and Beta-cyfluthrin, Tefluthrin, Chlorpyrifos, Diazinon, Dimethoate, Malathion, Phenthoate, Azinphos-methyl, DDVP, Fenamiphos, Methamidofos, Monocrotophos, Methidathion, Fipronil, Endosulfan, Dicofol, avermectin, abamectin, and ivermectin, Novaluron, Buprofezin, Flufenoxuron, Triflunuron, Lufenuron, Diafenthiuron, Cyromazine, Imidaclopride, Thiamethoxam, Niclosamide, Thiacloprid, Clofentezine, Pymetrozine, Fosthiazate, Emamectin benzoate, or mixtures of any of the above.

The fungicide may be for example Captan, Folpet, Tebuconazole, Epoxiconazole, Propiconazole, Thiabendazole, Triticonazole, Cyproconazole, Prothioconazole, Triadiminol, Difenoconazole, Kresoxim-Methyl, Azoxystrobin, Pyraclostrobin, Metominostrobin, Trifloxystrobin, Imazalil, Chlorothalonil, Fenamidon, Prochloraz, Pyrimethanil, Cyprodinil, Mefenoxam, or mixtures of any of the above.

Moreover according to a preferred embodiment of the present invention, the silica shell is produced by a sol-gel process comprising in-situ polymerization of silicon alkoxide monomers having the formula Si(OR)₄ where R is C₁-C₆ alkyl.

Preferably the silicon alkoxide monomer is selected from tetramethoxy silane, tetraethoxy silane, and mixtures thereof.

According to a preferred embodiment of the present invention, the microcapsules are prepared by a process comprising:
preparing an oil-in-water emulsion by emulsification of a water insoluble liquid phase comprising a water insoluble silicon alkoxide monomers having the formula Si(OR)₄ where R is C₁-C₆ alkyl and the core material, in an aqueous phase comprising an aqueous solution having a pH in the range 2-13, under appropriate shear forces and temperature conditions.

Additionally according to a preferred embodiment of the present invention, the pH is in the range 2-7.

According to a preferred embodiment of the present invention the weight ratio of said silicon alkoxide monomers to said core material is in the range 0.2:99.8 to 30:70.

According to a more preferred embodiment of the present invention the weight ratio of said silicon alkoxide monomers to said core material is in the range 0.2:99.8 to 9:91.

According to even more preferred embodiment the of the present invention the weight ratio of said silicon alkoxide monomers to said core material is in the range 0.2:99.8 to 3:97. Preferably weight ratio may said silicon alkoxide monomers to said core material is in the range 0.2:99.8 to 2.8:97.2.

Further according to even more preferred embodiment of the present invention, the weight ratio of said silicon alkoxide monomers to said core material is in the range 0.2:99.8 to 1:99.

According to a preferred embodiment of the present invention, the composition providing a knock down effect and reduced toxicity. The toxicity may be as described above. By “knock down effect” is meant an effect causing preferably 80-100% mortality of the pest (such as insect, fungi, weed and the like) within 24 hours after application, thus providing an acute treatment of pest-infested crop.

According to a preferred embodiment of the present invention, the composition having reduced toxicity and at least essentially the same pesticidal effect as compared to a reference composition; the difference between said composition and the reference composition being in that in the latter the pesticide is not coated.

The method and composition for acute treatment may be characterized by additional features as described above in the present invention with respect to the process for providing pesticide activity with immediate onset and prolonged effect.

It should be understood that the invention is not limited in its application to the details of construction and the arrangement of the components set forth in the following description. The invention includes other embodiments and can be practiced or implemented in various ways. Also, it is to be understood that the phraseology and terminology employed herein is for the purpose of description only and should not be regarded as limiting.

### EXAMPLES

The following examples clarify and demonstrate the present invention. They are not under any circumstances exclusive and do not intend to limit the scope of the present invention.

### Example #1

### Encapsulation of Diazol

85 g Diazol were mixed with 15 g tetraethoxysilane (TEOS) in an ice bath to obtain temperature of 10-15° C. This solution was emulsified with 100 g cold aqueous solution containing 0.5% cetyltrimethyl ammonium chloride (CTAC) under high sheer force. A Polytron PT-6100 equipped with PTA 45/6 dispersing tool was used at 12,000 rpm for 4 minutes. The vessel walls were cooled by immersion in an ice bath during the homogenization process. The emulsion was poured into an IKA LR-A 1000 laboratory reactor, equipped with Eurostat Power control-visc P4 stirrer, containing 10 g water and 0.04 g HCl 1N. The reaction was stirred at 300 rpm for 15 minutes, and then at 60 rpm for 24 h /room temperature. Then, it was diluted with 1.5 L de-ionized water containing 1.0% dispersing agent such as poly vinyl pyrrolidone (PVP), and the capsules were separated by centrifugation at 12,000 rpm for 15 minutes. The capsules were re-suspended in de-ionized water containing 1% emulsifier such as PVP to obtain 50% encapsulated Diazol. A CS (capsule suspension) formulation of 240 g/l (24% w/v) was prepared using the encapsulated Diazole, wetting and dispersing agents, antifreeze, thickening agents and preservatives. The pH was adjusted with buffer solution to 7. Final particle size distribution of the product was d(0.9)=3 μm.

### Example #2

### Encapsulation of Chlorpyrifos

Two samples of encapsulated Chlorpyrifos were prepared at two core/shell ratios. Sample #1: 255 g Chlorpyrifos (CPS) were heated to 45 C until homogenous melt of CPS was obtained. The melt was mixed with 45 g TEOS and 0.3 g Glyceryl mono isostearate (GMIS) and the solution was kept heated to 45-50° C. Sample #2: 285 g CPS were heated to 45 C until homogenous melt of CPS was obtained. The melt was mixed with 15 g TEOS and 0.3 g Glyceryl mono isostearate (GMIS) and the solution was kept heated to 45-50° C. Two solutions of 2% CTAC/water were heated to 45-50° C., in separate IKA LR-A 1000 laboratory reactors, equipped with Eurostat Power control-visc P4, and an Ultra-Turax T-25 equipped with S 25 KR-18G (IKA) dispersing tools. The hot organic phases were added to the aqueous phases and homogenized at 12,000 rpm for 4 minutes. The vessels were heated during the homogenization process to avoid crystallization of the active ingredient. A solution of 44 g water and 0.2 g HCl 1N were added to the emulsions. The reactions were stirred at 100 rpm for 15 minutes, and then at 60 rpm for 24 hours at room temperature followed by separation using centrifuge for 15 minutes at 12,000 rpm. In both samples the capsules were re-suspended in de-ionized water containing 1% emulsifier such as PVP to obtain 50% encapsulated CPS. Two identical CS (capsule suspension) formulation of 250 g/l (25% w/v) were prepared using the encapsulated CPS, wetting and dispersing agents, antifreeze, thickening agents and preservatives. The pH was adjusted with buffer solution to 7. Final particle size distribution of the products was d(0.9)=3.5 μm.

### Example #3

### Encapsulation of Bifenthrin

100 g Bifenthrin was dissolved in 160 g solvesso 150 (Aromatic C9—by Exxon USA) by heating to 50° C. 14 g (TEOS) and 2 g surfactant PVA (Polyvinyl alcohol) were added, and heating was continued to obtain a clear solution (Examples of surfactants that may be used: Polyvinylpyrrolidone (PVP), Polyvinyl alcohol (PVA), Span 80, Castor oil Ethoxylated (Emulan EL), Synpheronic L-64 and Atlox 4913 (from Uniquema)). The organic phase was added to 300 g solution of 0.8% CTAC in de-ionized water at 50° C., and emulsified under high sheer force. A Polytron PT-6100 equipped with PTA 45/6 dispersing tool was used at 16,000 rpm for 4 minutes. The emulsion was heated to 50-55° C. during the homogenization process to avoid precipitation of the active material. 0.25 g HCl 1N was added and the reaction was stirred for 12 h/50° C. and cooled to room temp. The reaction was centrifuged for 15 minutes at 12,000 rpm /room temperature. The capsules were re-suspended in de-ionized water containing 1% emulsifier such as PVP to obtain 30% encapsulated Bifenthrin. A CS (capsule suspension) formulation of 100 g/l (10% w/v) was prepared using the encapsulated Bifenthrin, wetting and dispersing agents, antifreeze, thickening agents and preservatives. The pH was adjusted with buffer solution to 7. Final particle size distribution of the product was d(0.9)=2.5 μm.

### Example #4

### Potency and Residual Activity of Cotton Leaves Treated with 30 mg Chlopyrifos/Liter of Chlorpyrifos Formulations on 1^{st}-Instar Helicoverpa armigera

Two encapsulated Chlopyrifos (CPS) formulations we produced according to example #2. In sample #1 the CPS/TEOS ratio was 85/15 resulting in CPS/silica ratio of 94.5/5.5. In sample #2 the CPS/TEOS ratio was 95/5 resulting in CPS/silica ratio of 98.3/1.7

| Chlorpyrifos | Percent larval mortality at various days after application | | | | | |
|---|---|---|---|---|---|---|
| Formulations | 1 | 5 | 14 | 20 | 27 | 39 |
| Control | 12 ± 6 | 8 ± 5 | 12 ± 8 | 2 ± 2 | 0 | 0 |
| *Dursban | 100 | 88 ± 6 | 54 ± 8 | 24 ± 10 | 12 ± 7 | 6 ± 5 |
| 480 EC | | | | | | |
| 25 CS- | 54 ± 5 | 90 ± 6 | 90 ± 8 | 95 ± 1 | 85 ± 6 | 76 ± 11 |
| Sample #1 | | | | | | |
| 25 CS- | 100 | 98 ± 2 | 98 ± 2 | 98 ± 2 | 72 ± 11 | 38 ± 8 |
| Sample #2 | | | | | | |

*Dursban 480 EC is an insecticidal formulation containing 480 gr/liter of Chlorpyrifos (un-encapsulated). It is produced by Dow agrosciences USA.

Cotton seedlings were treated with 30 mg Chlopyrifos/liter of each of the Chlopyrifos formulations and their leaves were exposed periodically to 1^{st}-instar Helicoverpa armigera for 4-day feeding. Mortality was then determined. Assays carried out at standard laboratory conditions of 25±1° C. and light: dark of 14:10 h (14 hrs and 10 minutes). Data are averages±SEM of 5 replicates of 10 larvae each.

Results. Data obtained thus far indicate that the starting potency of 25 CS #2 resembles that of the Dursban 480 EC formulation resulting in 100% mortality with both formulations. The 25 CS #2 maintained its potency until day 14, while that of the EC formulation lost gradually its potency, resulting in 54% mortality at day 14.

The other 25 CS formulation, #1, have lower potency at day 1, 54% mortality. From day 5 mortality increases to the level of 25 CS #2 maintaining it's potency until day 14.

At day 20, both CS formulations maintained their high potency, while the EC formulation lost most of its activity.

At days 27 and 39, both 25 CS formulations start to loose some activity. It is of interest to note that 25 CS #1 shows lower decrease in its activity especially at day 39.

At day 39, both CS formulations maintained some of their activities while the EC formulation lost totally its activity. It can be noted that the leaves after 39 days are larger in size and therefore the amount of toxicant per area is much lower.

### Example #5

Two encapsulated Chlopyrifos formulations we produced according to example #2.

In sample #1 the CPS/TEOS ratio was 85/15 resulting in CPS/silica ratio of 94.5/5.5 (SGT060222).

In sample #2 the CPS/TEOS ratio was 95/5 resulting in CPS/silica ratio of 98.3/1.7 (SGT060224).

Dursban 480 EC (an insecticidal formulation containing 480 gr/liter of Chlorpyrifos (un-encapsulated) produced by Dow agrosciences USA was perchased at Hagarin store in Rehovot, Israel.

| | | Rat | | | | |
|---|---|---|---|---|---|---|
| | Dosage | weight | Mortality | | LD50 | |
| Sample | (mg/kg) | (gr) | Males | Females | Males | Females |
| Dursban | 50 | 175-200 | 3/5 | 1/5 | | |
| 480 EC | | | | | | |
| | 500 | 175-200 | 5/5 | 5/5 | 35 | 94 |
| | 2000 | 175-200 | 5/5 | 5/5 | | |
| SGT | 50 | 175-200 | 0/5 | 0/5 | | |
| 060222 | | | | | | |
| | 2000 | 175-200 | 0/5 | 0/5 | No mortality | 5095 |
| | 5000 | 175-200 | 2/5 | 0/5 | | |
| SGT | 50 | 175-200 | 0/5 | 0/5 | | |
| 060224 | | | | | | |
| | 500 | 175-200 | 1/5 | 0/5 | 552 | 1236* |
| | 2000 | 175-200 | 5/5 | 5/5 | | |

*Additional dosage in the range of 500-2000 mg/kg is needed in order to determing exact LD50

The evaluation of acute oral toxicity of the crop protection formulations was done according to the OECD guideline for testing of chemicals using the acute toxic class method. The method uses pre-defined doses and the results allow a substance to be ranked and classified according to the globally harmonized system for the classification of chemicals, which cause acute toxicity. It is a stepwise procedure in which the substance is administrated orally to a group of experimental animals at one of the defined doses. In each step the substance was administrated to 5 rats of each sex. Absence or presence of compound-related mortality of the rats dosed at one step will determine the next step. The animals were selected to be healthy young adults between 8 to 12 weeks old. The substance was administrated at a constant volume over the range of doses to be tested by varying the concentration of the dosing preparation. The substance was prepared shortly prior to administration and was diluted by water. Animals were fasted and weighed prior to dosing. The test substance was administrated in a single dose by gavage using a stomach tube. Animals were observed individually after dosing at least once during the first 30 minutes, periodically during the first 24 hours, with special attention given during the first 4 hours, and daily thereafter, for a total of 14 days, except where they need to be removed from the study and humanely killed for animal welfare or were found dead. Tested animals were not used again for the next steps.

Results: high mortality (low LD50) were obtained by the commercial formulation of CPS Dursban 480 EC. These results are equivalent to LD of the active ingredient reported in the literature. On the other hand, the silica encapsulated CPS is 10-50 times less toxic. Almost no mortality was observed in the thick silica shell product (SGT 060222) defining the product as non-toxic compared to low level of toxicity in the thin silica shell product (SGT 060224).

### Example #6

### Encapsulation of Propiconazole

90 g Propiconazole (a fungicide) are mixed with 10 g tetraethoxysilane (TEOS) in a hot bath to obtain temperature of 40-45° C. This solution is emulsified with 100 g hot (40-45 C) aqueous solution containing 1% cetyltrimethyl ammonium chloride (CTAC) under high sheer force. A Polytron PT-6100 equipped with PTA 45/6 dispersing tool is used at 12,000 rpm for 8 minutes. The vessel walls are heated by immersion in a hot bath (40-45 C) during the homogenization process. The emulsion is poured into an IKA LR-A 1000 laboratory reactor, equipped with Eurostat Power control-visc P4 stirrer, containing 10 g water and 0.04 g HCl 1N. The reaction is stirred at 250 rpm for 15 minutes, and then at 60 rpm for 24 h at 40-45 C. Then, it is diluted with 1.5 L de-ionized water containing 1.0% dispersing agent such as polyethylene oxide polypropylene oxide block co polymers, and the capsules are separated by centrifugation at 10,000 rpm for 15 minutes. The capsules are re-suspended in de-ionized water containing 1% emulsifier such as PVP to obtain 50% encapsulated Propiconazole. A CS (capsule suspension) formulation of 250 g/l (25% w/v) is prepared using the encapsulated Propiconazole, wetting and dispersing agents, antifreeze, thickening agents and preservatives.

### Example #7

### Encapsulation of Propaquizafop

100 g Propaquizafop (herbicide) is dissolved in 80 g solvesso 200 (Aromatic C10—by Exxon USA) by heating to 50° C. 10 g (TEOS) and 2 g tween 80 are added, and heating is continued to get a clear solution. The organic phase is added to 200 g solution of 1% CTAC in de-ionized water at 50° C., and emulsified under high sheer forces. A Polytron PT-6100 equipped with PTA 45/6 dispersing tool is used at 18,000 rpm for 6 minutes. The emulsion is heated to 50-55° C. during the homogenization process to avoid precipitation of the active material. 0.25 g HCl 1N is added and the reaction is stirred for 12 h at room temp. The reaction is centrifuged for 15 minutes at 12,000 rpm /room temperature. The capsules are re-suspended in de-ionized water containing 1% emulsifier such as PVP to obtain 35% encapsulated Propaquizafop. A CS (capsule suspension) formulation of 100 g/l (10% w/v) is prepared using the encapsulated Propaquizafop, wetting and dispersing agents, antifreeze, thickening agents and preservatives.

While this invention has been shown and described with reference to preferred embodiments thereof, it will be understood by those skilled in the art that many alternatives, modifications and variations may be made thereto without departing from the spirit and scope of the invention. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference.

1-32. (canceled)

33. A method for crop protection comprising administering to one or both of the crop and its environment a composition comprising a carrier; and microcapsules having a core material comprising a pesticide encapsulated by a silica shell, wherein the silica shell constitutes up to 10% w/w out of the total weight of the microcapsules, and wherein said administration gives rise to pesticide activity with immediate onset and prolonged effect.

34. The method of claim 33, wherein the pesticide is a solid when mixed with tetraethoxysilane at room temperature.

35. The method of claim 33, wherein the core material comprises a water insoluble liquid.

36. The method of claim 35, wherein said pesticide is dissolved or dispersed in said liquid core.

37. The method of claim 33, wherein said silica shell is produced by a sol-gel process comprising in-situ polymerization of silicon alkoxide monomers having the formula Si(OR)₄ where R is C₁-C₆ alkyl.

38. The method of claim 37, wherein said silicon alkoxide monomer is selected from tetramethoxy silane, tetraethoxy silane, and mixtures thereof.

39. The method of claim 33, wherein said microcapsules are prepared by a process comprising:
emulsifying a water insoluble liquid phase comprising a water insoluble silicon alkoxide monomers having the formula Si(OR)₄ where R is C₁-C₆ alkyl and the core material, in an aqueous phase comprising an aqueous solution having a pH in the range 2-13, under appropriate shear forces and temperature conditions and applying conditions for the formation of said shell.

40. The method of claim 39, wherein said pH is in the range 2-7.

41. The method of claim 40, wherein the weight ratio of said silicon alkoxide monomers to said core material is in the range 3:97 to 30:70.

42. The method of claim 33, wherein said composition providing a knock down effect and reduced toxicity.

43. The method of claim 33, wherein said composition having reduced toxicity and at least essentially the same pesticidal effect as compared to a reference composition; the difference between said composition and the reference composition being in that in the latter the pesticide is not coated.

44. The method of claim 33, for acute treatment of a pest-infested crop.

45. The method of claim 44, wherein said composition provides a knock down effect and reduced toxicity.

46. The method of claim 33, wherein said pesticide is selected from the group consisting of tebuconazole, lambda-cyhalothrin, diazinon, cypermethrin, diazol, chlorpyriphos, bifenthrin, propiconazole and propaquizafop.

47. The method of claim 33, wherein said pesticide is selected from the group consisting of diazol, chlorpyriphos, bifenthrin, propiconazole and propaquizafop.

48. A method of preparing a microcapsule having a core material comprising a pesticide, which method comprises preparing an oil-in-water emulsion of a water insoluble liquid phase comprising a water insoluble silicon alkoxide monomer of the formula Si(OR)₄ where R is C₁-C₆ alkyl and the core material, in an aqueous phase comprising an aqueous solution having a pH in the range of 2-13, under appropriate shear forces and wherein such emulsion is homogenized at a temperature sufficient to avoid crystallization of the core material.

49. The method of claim 48, wherein said pesticide is a solid when mixed with tetraethoxysilane at room temperature.

50. The method of claim 49, wherein said pesticide is selected from the group consisting of tebuconazole, lambda-cyhalothrin, diazinon, cypermethrin, diazol, chlorpyriphos, bifenthrin, propiconazole and propaquizafop.

51. The method of claim 49, wherein said pesticide is selected from the group consisting of diazol, chlorpyriphos, bifenthrin, propiconazole and propaquizafop.
